(19) United States
(12) Patent Application Publication
(10) Pub. No.: US 2023/0130830 A1
(43) Pub. Date: Apr. 27, 2023

(54) DISTANCE IMAGE CAPTURING SYSTEM ADJUSTING NUMBER OF IMAGE CAPTURING OPERATIONS

(71) Applicant: FANUC CORPORATION, Yamanashi (JP)

(72) Inventors: Minoru NAKAMURA, Yamanashi (JP); Fumikazu WARASHINA, Yamanashi (JP); Yuuki TAKAHASHI, Yamanashi (JP)

(21) Appl. No.: 17/905,642

(22) PCT Filed: Mar. 8, 2021
(86) PCT No.: PCT/JP2021/009022

§ 371 Date: Sep. 5, 2022

(30) Foreign Application Priority Data
Mar. 12, 2020 (JP) 2020-043475

(51) Int. Cl. G06V 10/74; G06T 5/50; G06V 10/25; B25J 9/16

(52) U.S. Cl. CPC G06V 10/761; G06T 5/50; G06V 10/25; B25J 9/1664; G06T 2207/20221

(57) ABSTRACT

A distance image capturing system including: an image acquisition unit for capturing a plurality of images of an object at the same image capturing position and in the same image capturing orientation with respect to the object to acquire a plurality of first distance images; an image synthesis unit for synthesizing the plurality of first distance images to generate a second distance image; and a number-of-image-capturing-operation determination unit for estimating a distance measurement error in the second distance image and determining the number of image capturing operations for the first distance images at which the estimated distance measurement error is equal to or less than a predetermined target error.

### TECHNICAL FIELD

The present invention relates to a distance image capture system, and in particular, to a distance image capture system which adjusts an imaging number.

### BACKGROUND ART

As distance measurement sensors which measure the distance to an object, TOF (time of flight) sensors, which output distance based on the time of flight of light, are known. TOF sensors irradiate a target space with reference light, which is intensity-modulated in predetermined cycles, and in many cases, a phase difference method (the so-called “indirect method”), in which a distance measurement value of the target space is output based on the phase difference between the reference light and light reflected from the target space, is adopted. This phase difference is obtained from the amount of reflected light received.

There are variations in the distance measurement values of such distance measurement sensors represented by TOF sensors. Though the main cause of distance measurement variations is shot noise in the case of TOF sensors, it is known that such distance measurement variations vary in a substantially normally distributed manner. Though it is effective to increase the integration time and the amount of light emitted by the TOF sensor in order to reduce variations, this solution has limitations in the specifications of the distance measurement sensor, such as restrictions on the amount of light received by the light-receiving element of the distance measurement sensor and restrictions on heat generation.

When detecting the position or posture of an object from a distance image, in order to maintain detection accuracy, it is desirable that the error of the distance image be equal to or less than a specified value. As another solution for reducing variability, the adoption of an averaging process in which the distance for each corresponding pixel in a plurality of distance images are averaged, a time filter such as an IIR (infinite impulse response) filter, or a spatial filter such as a median filter or a Gaussian filter may be considered.

FIG. 8 shows a conventional distance image averaging process. The lower left side of the drawing shows a perspective view in which there is shown a distance image in which a surface of a certain height when viewed from the distance measurement sensor is captured. Furthermore, the upper left side of the drawing shows an average value μ of the distance measurement values of each pixel in the surface region of this distance image and a variation σ of the distance measurement values. When N of such distance images are acquired and an averaging process is performed, as shown on the upper right side of the drawing, the variation σ of the distance measurement value of each pixel is reduced to σ/N^{0.5}, and as shown on the lower right side of the drawing, a composite distance image, which is an image of a substantially flat surface, is generated. As technologies related to composite processing of such distance images, the following literature is known.

Patent Literature 1 describes calculating, for a plurality of distance images captured while changing exposure step by step, the weighted average value of distance information of each pixel corresponding to the same pixel position to obtain a composite distance image which is composited so that the calculated weighted average value is the distance information of each pixel, wherein the calculation of the weighted average value uses a weighted coefficient which is calculated so as to correspond to the accuracy of the distance information according to the light receiving level information of the pixel.

Patent Literature 2 describes extracting pixels representing a greater received light intensity between a plurality of distance images acquired under different imaging conditions based on the received light intensity associated with each pixel in the distance images, and using the extracted pixels in a composite distance image of a plurality of distance images.

Patent Literature 3 describes acquiring a plurality of sets of image data having different imaging sensitivities for each predetermined unit area, executing in-plane HDR (high dynamic range) processing to generate image data with an expanded dynamic range by compositing the plurality of sets of image data, and performing control so that the direction in which more features of a target appear becomes the HDR processing direction.

### CITATION LIST

### Patent Literature

[PTL 1] JP 2012-225807 A
[PTL 2] JP 2017-181488 A
[PTL 3] JP 2019-57240 A

### SUMMARY OF INVENTION

### Technical Problem

The distance image imaging number used in the averaging processing, etc., described above is generally a predetermined fixed number. However, in composite processing of a fixed number of distance images, it becomes difficult to reduce distance measurement variations caused by changes of the target, whereby distance measurement accuracy becomes unstable.

FIG. 9 shows examples of an increase in variation due to changes of a target. As shown on the left side of the drawing, the distance measurement sensor 10 outputs a predetermined number of distance images, and can acquire a composite distance image with a small distance measurement variation for a target W. However, as shown in the center of the drawing, when the distance from the distance measurement sensor 10 to the target W becomes significant, the amount of light received by the distance measurement sensor 10 decreases, whereby distance measurement variations increase. Likewise, as shown on the right side of the drawing, when the reflectance of the target W becomes low (for example, when changing to a dark target W), the amount of reflected light decreases, whereby distance measurement variations increase. Thus, it is difficult to guarantee reduction of variations with a fixed number of composite distance images.

Conversely, increasing the imaging number by giving a margin to the fixed number has been considered. However, in most cases, time will be wasted on image acquisition and image compositing. Thus, the imaging number of the distance image should be variable in accordance with the situation of the target.

Thus, there is a demand for a distance image composting technology which can realize stable distance measurement accuracy and reduction of wasted time, even if the target changes.

### Solution to Problem

One aspect of the present disclosure provides a distance image capture system, comprising an image acquisition unit which acquires a plurality of first distance images by imaging a target multiple times from the same imaging position and the same imaging posture with respect to the target, and an image composition unit which generates a second distance image by compositing the plurality of first distance images, the system comprising an image count determination unit which estimates a distance measurement error in the second distance image and determines an imaging number of the first distance images so that the estimated distance measurement error becomes equal to or less than a predetermined target error.

### Advantageous Effects of Invention

According to the aspect of the present disclosure, since the imaging number is automatically adjusted, there can be provided an image compositing technology that achieves stable distance measurement accuracy and a reduction of wasted time, even if the target changes.

### BRIEF DESCRIPTION OF DRAWINGS

FIG. 1 is a block diagram showing the structure of a distance image capture system of an embodiment.

FIG. 2 is a graph detailing an imaging number determination method by a function method.

FIG. 3 is a flowchart showing the flow of an imaging number determination process by the function method.

FIG. 4 is a graph detailing an imaging number determination method by a sequential method.

FIG. 5 is a flowchart showing the flow of an imaging number determination process by the sequential method.

FIG. 6 is a graph detailing a modified example of an imaging number determination method.

FIG. 7 is a block diagram showing a modified example of the structure of a distance image capture system.

FIG. 8 is a schematic view showing conventional distance image averaging processing results.

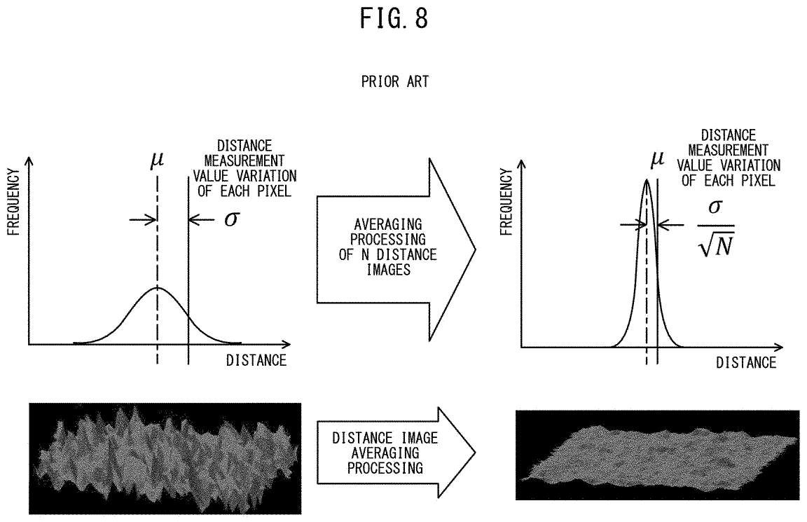

FIG. 9 is a schematic view showing an example of variation increase due to changes of a target.

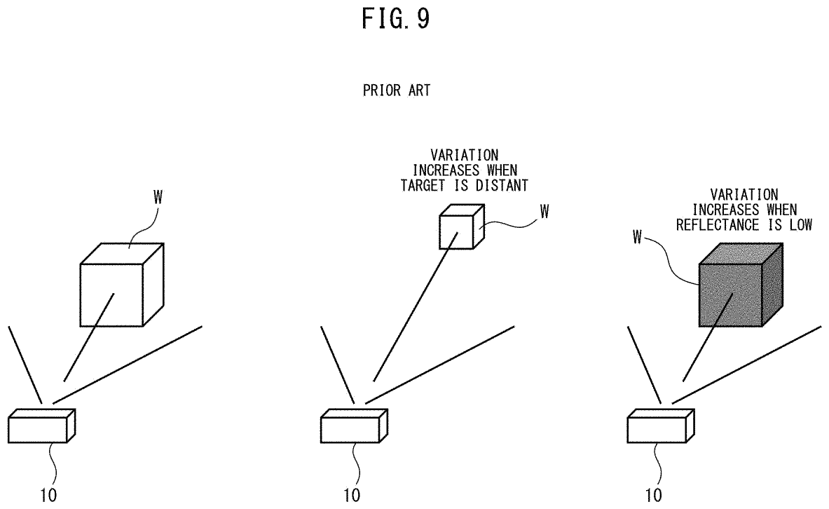

### DESCRIPTION OF EMBODIMENTS

The embodiments of the present disclosure will be described in detail below with reference to the attached drawings. In the drawings, identical or similar constituent elements have been assigned the same or similar reference signs. Furthermore, the embodiments described below do not limit the technical scope of the invention described in the claims or the definitions of the terms. Note that the description “distance image” as used herein refers to an image in which distance measurement values from a distance measurement sensor to a target space are stored for each pixel, and the description “light intensity image” refers to an image in which light intensity values of the reflected light reflected in the target space are stored for each pixel.

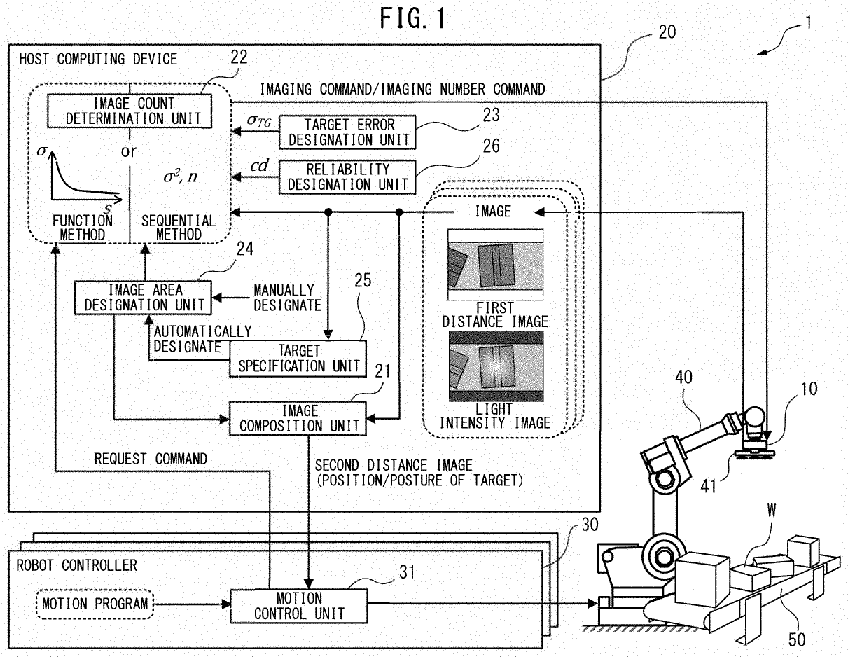

FIG. 1 shows the structure of a distance image capture system 1 of the present embodiment. The distance image capture system 1 comprises an image acquisition unit 10 which outputs a distance image of a target space including a target W, and a host computing device 20 which controls the distance measurement sensor 10. The image acquisition unit 10 may be a TOF sensor such as a TOF camera or a laser scanner, or may be another distance measurement sensor such as a stereo camera. The host computing device 20 is wired or wirelessly communicably connected to the image acquisition unit 10. The host computing device 20 comprises a processor such as a CPU (central processing unit), an FPGA (field-programmable gate array), and an ASIC (application specific integrated circuit). All of the constituent elements of the host computing device 20 may be implemented as a part of the functions of the distance measurement sensor.

The image acquisition unit 10 acquires a plurality of first distance images by imaging the target W multiple times from the same imaging position and the same imaging posture with respect to the target W. The image acquisition unit 10 preferably has a function of acquiring, in addition to the first distance images, light intensity images by capturing the target W from the same imaging position and the same imaging posture.

The host computing device 20 comprises an image composition unit 21 which generates a second distance image by compositing the plurality of first distance images acquired by the image acquisition unit 10. Though the image composition unit 21 generates the second distance image by averaging the plurality of first distance images for each corresponding pixel, it may generate the second distance image by applying, to the plurality of first distance images, a time filter such as an IIR filter, a spatial filter such as median filter, a Gaussian filter, or filter processing combining these. Such a composite distance image reduces distance measurement variations.

The host computing device 20 preferably further comprises an image area designation unit 24 which designates an image area of a composited target. The image area of the composited target may be, for example, a specific area of the target W (for example, a surface of the target W to be suctioned or a surface on which a predetermined operation (spot welding, sealing, fastening, etc.) is applied to the target W). The image area of the composited target may be manually designated by the user, or may be automatically designated by the host computing device 20. In the case of manual designation, for example, an input tool or the like for the user to designate the image area in the acquired distance image or light intensity image is preferably provided. By limiting the image area of the composited target, composition processing of the distance image can be accelerated.

The host computing device 20 may further comprise a target specification unit 25 which automatically specifies an image area in which at least a part of the target W is captured from the distance image or the light intensity image. As the method for specifying the target W, a known method such as matching processing such as pattern matching, blob analysis for analyzing feature amounts of the image, and clustering for classifying similar regions can be used. The specified image area is designated as the image area of the composited target by the image area designation unit 24.

The distance image capture system 1 can be applied to, for example, a robot system. The distance image capture system 1 further comprises a robot 40 and a robot controller 30 that controls the robot 40, and the robot controller 30 issues a second distance image request command to the host computing device 20, and can correct the motion of the robot 40 based on the second distance image (i.e., at least one of the position and posture of the target W; the same applies below) acquired from the host computing device 20.

In a robot system comprising a plurality of robots 40 and a plurality of robot controllers 30, it is preferable that the host computing device 20 be communicably connected to the robot controller 30 in a one-to-many manner. According to such a server configuration, the host computing device 20 side is responsible for high-load image processing, and the robot controllers 30 side can concentrate performance on control processing of the robots 40.

Though the robot 40 is an articulated robot, it may be another industrial robot such as a parallel link type robot. The robot 40 preferably further comprises a tool 41 which performs operations on the target W. The tool 41 may be a hand which grips the target W, or may be another tool which performs a predetermined operation (spot welding, sealing, fastening, etc.) on the target W. Though the target W is transported by a conveyance device 50 and arrives in the operation area of the robot 40, a system configuration in which targets W are stacked in bulk on a pallet (not illustrated) or the like may be adopted. The conveyance device 50 may be a conveyor, or may be another conveyance device such as an automated guided vehicle (AGV).

The image acquisition unit 10 is installed on the tip of the robot 40, but may be installed at a fixed point different from the robot 40. The robot controller 30 comprises a motion control unit 31 which controls the motion of the robot 40 and the tool 41 in accordance with a motion program generated in advance by a teaching device (not illustrated). When the target W arrives in the operation area of the robot 40, the motion control unit 31 temporarily stops the conveyance device 50 and issues a second distance image request command to the host computing device 20. However, a second distance image request command may be issued to the host computing device 20 while the tip of the robot 40 follows the motion of the target W.

When the conveyance device 50 is temporarily stopped, the image acquisition unit 10 acquires the plurality of first distance images of the stationary target W from the same imaging position and the same imaging posture. Conversely, when the robot 40 follows the motion of the target W, the image acquisition unit 10 acquires the plurality of first distance images of the moving target W from the same imaging position and the same imaging posture. The motion control unit 31 corrects the motion of at least one of the robot 40 and the tool 41, based on the second distance image acquired from the host computing device 20.

The host computing device 20 is characterized by comprising an image count determination unit 22 which determines a first distance image imaging number. Upon receiving a second distance image request command, the image count determination unit 22 issues an imaging command to the image acquisition unit 10 and acquires the plurality of first distance images. The image count determination unit 22 estimates the distance measurement error in the second distance image, and determines the first distance image imaging number so that the estimated distance measurement error becomes less than or equal to a predetermined target error. Note that instead of the imaging number, the image count determination unit 22 may determine the number of acquired first distance images that the image composition unit 21 acquires from the image acquisition unit 10, or alternatively, when the image composition unit 21 generates the second distance image using a time filter, the time constant of the time filter may be determined. There are two imaging number determination methods, such as a function method and a sequential method, and these two imaging number determination methods will be described in order below.

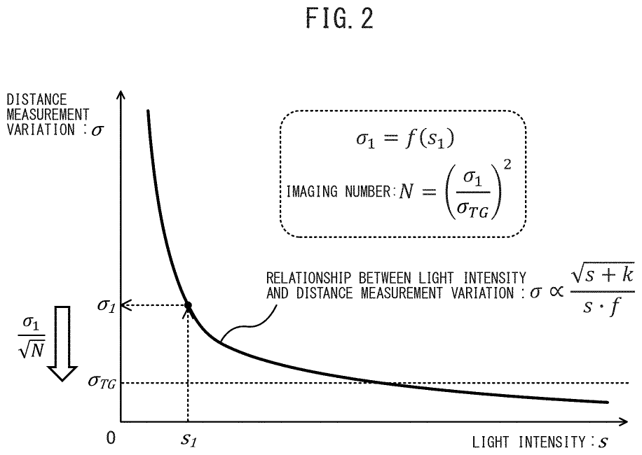

FIG. 2 shows a graph for detailing the imaging number determination method by the function method. Generally, in TOF sensors, a light intensity image can be acquired at the same time as a distance image, and there is a certain correlation between the light intensity value s in the light intensity image and the distance measurement variation σ in the distance image, as shown in the graph. This graph is approximated by the following formula. Here, f is the emission frequency of reference light, and A and k are constants including differences in the specifications of the components of the distance measurement sensor 10 and variations in individual characteristics. A and k of the following formula can be experimentally acquired in advance or acquired as calibration data at the time of shipment.

$$\begin{matrix}[ Math 1 ] & \\ σ = A \cdot \frac{\sqrt{s + k}}{s \cdot f} & 1\end{matrix}$$

According to the function method, the distance measurement error σ₁ in the first distance image can be estimated by acquiring the light intensity value s₁ from the acquired light intensity image in a first imaging, and substituting the acquired light intensity value s₁ into, for example, formula 1. Alternatively, the distance measurement error σ₁ in the first distance image may be obtained without using such an approximation formula by performing linear interpolation, polynomial interpolation, etc., on a data table in which there are stored a plurality of relationships between the light intensity value s and distance measurement variation σ acquired experimentally in advance or at the time of factory calibration. Furthermore, since the distance measurement error σ₁ in the first distance image has a generally normal distribution variation, it is known that the distance measurement variation of the second distance image, on which an averaging process was performed to average the distance for each corresponding pixel of the first distance image captured N times, is reduced by a reduction of 1/N^{0.5} by the central limit theorem of statistics. Specifically, when this distance measurement variation σ₁/N^{0.5} is considered as the distance measurement error in the second distance image, the distance measurement error σ₁/N^{0.5} in the second distance image can be estimated. Then, the imaging number N of the first distance images, in which the distance measurement error σ₁/N^{0.5} in the estimated second distance image is equal to or less than the predetermined target error σ_{TG}, is determined. In other words, when the plurality of first distance images are averaged to generate a second distance image, it is possible to determine the imaging number N based on the following formula. It should be noted that different degrees of reduction are applied to the distance measurement error of the second distance image when a compositing process other than the illustrated averaging process is adopted.

$$\begin{matrix}[ Math 2 ] & \\ N = {( \frac{{σ}_{1}}{{σ}_{TG}} )}^{2} & 2\end{matrix}$$

Referring again to FIG. 1, when the imaging number is determined by the function method, the image count determination unit 22 determines the first distance image imaging number based on the light intensity images acquired from the image acquisition unit 10. Specifically, the image count determination unit 22 estimates the distance measurement error σ₁/N^{0.5} in the second distance image from the light intensity images based on the relationship (formula 1) between the light intensity value s in the light intensity images and the distance measurement variation σ in the distance images, and determines the imaging number N for which the estimated distance measurement error σ₁/N^{0.5} in the second distance image is equal to or less than the target error σ_{TG}.

Furthermore, when determining the imaging number, the image count determination unit 22 may estimate the distance measurement error in the second distance image in units of pixels in the light intensity images, or may estimate the distance measurement error in the second distance image in units of pixel regions in the light intensity images. Specifically, the image count determination unit 22 may estimate the distance measurement error in the second distance image based on the light intensity value of, for example, a specific pixel of target W, or may estimate the distance measurement error in the second distance image based on the average value or the lowest value of the light intensity value of a specific pixel region (for example, a 3×3 pixel region) of the target W.

Further, when determining the imaging number, at least one light intensity image may be acquired, or a plurality of light intensity images may be acquired. When a plurality of images are acquired, the image count determination unit 22 may estimate the distance measurement error in the second distance image based on the average value or the minimum value of the light intensity values of the corresponding pixels among the plurality of light intensity images, or may estimate the distance measurement error in the second distance image based on the average value or the lowest value of the light intensity values of the corresponding pixel regions (for example, 3×3 pixel regions) among the plurality of light intensity images. By using the light intensity value of more pixels in this manner, it is possible to estimate the distance measurement error in the second distance image (and thus the imaging number of the first distance images) with higher accuracy, or estimate the same so as to be less than or equal to the target error with high certainty.

In addition, when determining the imaging number, the target error σ_{TG} may be a predetermined fixed value, or may be a designated value designated by the user. In the case of a designated value, the distance image capture system 1 may further comprise a target error designation unit 23 which designates the target error σ_{TG}. For example, it is preferable that the user interface be provided with a numerical input field or the like for the user to designate the target error σ_{TG}. By enabling designation of the target error σ_{TG}, it is possible to generate the second distance image with the target error in accordance with a user request.

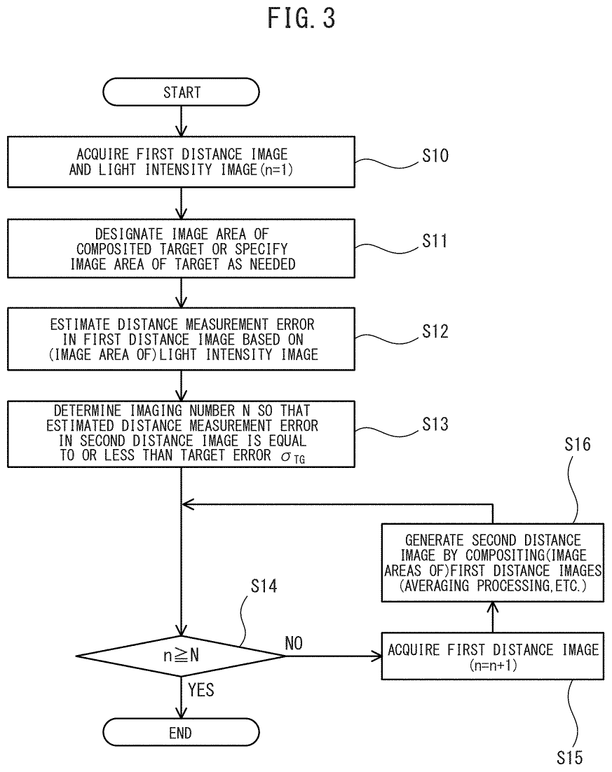

FIG. 3 shows the flow of an imaging number determination processing by the function method. First, in step S10, a first distance image and a corresponding light intensity image are acquired in a first imaging (n=1). It should be noted that a plurality of first distance images and a plurality of light intensity images corresponding thereto may be acquired by performing imaging a plurality of times (n=2, 3, etc.). In step S11, the image area of the composited target is manually designated based on the acquired image or the image area in which at least a part of the target W is captured is automatically specified as needed.

In step S12, the distance measurement error in the second distance image is estimated based on (the image area of) the light intensity image. The approximation formula 1, in which the relationship between the light intensity value s in (the image area of) the light intensity image and the distance measurement variation σ in the first distance image is represented, or linear interpolation or polynomial interpolation of a data table of light intensity value s and distance measurement variation σ is used in the estimation. At this time, the distance measurement error in the second distance image may be estimated in units of pixels in (the image area of) the light intensity image or in units of pixel regions in (the image area of) the light intensity image, or the distance measurement error in the second distance image may be estimated in units of corresponding pixels between (the image areas of) the plurality of light intensity images or in units of corresponding pixel regions between (the image areas of) the plurality of light intensity images.

In step S13, the distance measurement error σ₁/N_{0.5} of the second distance image is estimated based on the estimated distance measurement error at of the first distance images and, for example, the reduction degree 1/N^{0.5} of the distance measurement error of the second distance image generated by averaging the plurality of first distance images, and the imaging number N for which the estimated distance measurement error σ₁/N^{0.5} in the second distance image is equal to or less than the target error σ_{TG} is determined. When adopting filter processing other than averaging processing, different reduction degrees are adopted so as to determine the imaging number N.

In step S14, it is determined whether or not the current imaging number n has reached the determined imaging number N. When the current imaging number n has not reached the determined imaging number N in step S14 (NO in step S14), the process proceeds to step S15, a further first distance image is acquired (n=n+1), and in step S16, the process of compositing (the image areas of) the first distance images and generating the second distance image (by performing an averaging process or the like) is repeated. When the current imaging number n has reached the determined imaging number N in step S14 (YES in step S14), the compositing process of the first distance images is complete, and the second distance image at this time becomes the final second distance image.

Next, the imaging number determination method using the sequential method will be described. The distance measurement variation in the first distance images has a generally normally distributed variation, and when the distance measurement error in the first distance images to be estimated is expressed by its standard deviation σ, the distance measurement error of the second distance image, which is obtained by imaging the first distance image n times and averaging the distance for each corresponding pixel, is reduced to σₙ/n^{0.5}. The following formula is obtained, considering that the distance measurement error σₙ/n^{0.5} in the second distance image reduced in this manner is equal to or less than the target error σ_{TG}.

$$\begin{matrix}[ Math 3 ] & \\ \frac{{σ}_{n}}{\sqrt{n}} \leq {σ}_{TG} & 3\end{matrix}$$

When this formula is transformed, the following formula is obtained.

$$\begin{matrix}[ Math 4 ] & \\ n \geq \frac{{σ}_{n}^{2}}{{σ}_{TG}^{2}} & 4\end{matrix}$$

σₙ² is a value referred to as statistical distribution, and when the average of n sets of data from x₁ to xₙ is defined as μₙ, the distribution σₙ² is as indicated in the following formula.

$$\begin{matrix}[ Math 5 ] & \\ {σ}_{n}^{2} = \frac{1}{n} {\sum }_{i = 1}^{n} {( {x}_{i} - {μ}_{n} )}^{2} & 5\end{matrix}$$

Here, the average σₙ and distribution σₙ² can be obtained by sequentially calculating the data as shown in the following formulas, respectively.

$$\begin{matrix}[ Math 6 ] & \\ {μ}_{n + 1} = \frac{1}{n + 1} ( n {μ}_{n} + {x}_{n + 1} ) & 6\end{matrix}$$

$$\begin{matrix}[ Math 7 ] & \\ {σ}_{n + 1}^{2} = \frac{n ( {σ}_{n}^{2} + {μ}_{n}^{2} ) + {x}_{n + 1}^{2}}{n + 1} - {μ}_{n + 1}^{2} & 7\end{matrix}$$

Thus, every time the distance measurement value is obtained by imaging, by sequentially calculating the average μₙ and distribution σₙ² and determining with determination formula 4, which represents the relationship between the distribution σₙ² and the imaging number n, it can be estimated whether the distance measurement error σₙ/n^{0.5} of the average μₙ (i.e., the second distance image) is equal to or less than the target error σ_{TG}, whereby the imaging number n is automatically determined. If the composition method used is different and the degree of reduction of the distance measurement error with respect to the imaging number n is different, it is advisable to multiply the ratio of the degree of reduction by the right side of the determination formula 4 and perform judgment.

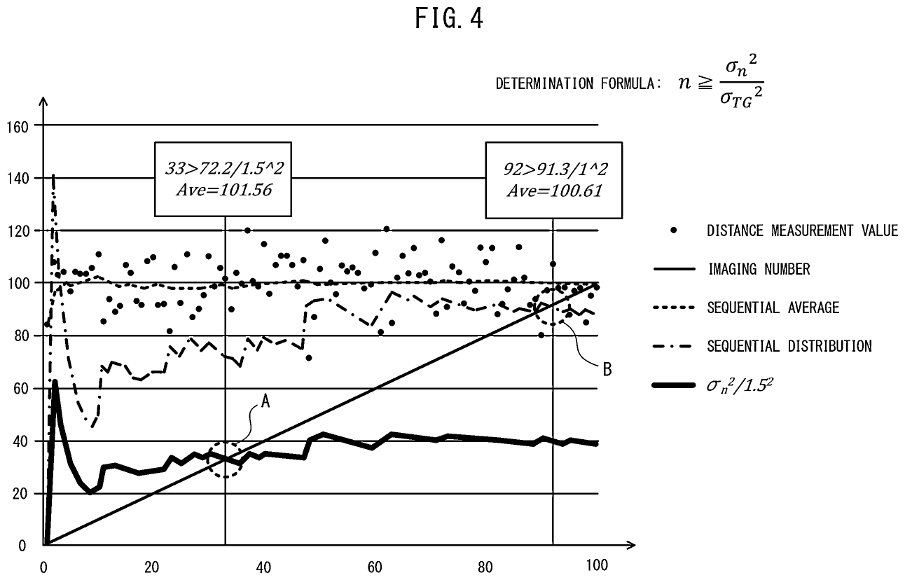

FIG. 4 shows a graph detailing this imaging number determination method by a sequential method. Here, the composition method of the second distance image is an averaging process in which the distance for each corresponding pixel of the first distance image is averaged. In FIG. 4, the horizontal axis of the graph represents the imaging number (the number of distance measurement values of a specific pixel), and the vertical axis of the graph represents distance (cm). FIG. 4 shows examples (black dots) in which a target W at an actual distance of 100 cm is imaged 100 times (i.e., 100 distance measurement values are acquired). In the sequential method, the sequential average (broken line) and the sequential distribution (dashed-dotted line) of the distance measurement values are calculated each time a first distance image is captured.

FIG. 4 also shows sequentially-calculated values of the right-hand side value αₙ²/1.5² (thick line) of the determination formula 4 when the target error σ_{TG} is 1.5 cm. Reference sign A represents the time point at which the current imaging number n (solid line) exceeds σₙ²/1.5² (thick line), indicating that the condition of the determination formula 4 is satisfied. Specifically, when the imaging number n of the first distance image represents a 33rd repetition, it is ultimately shown that the distance measurement error σₙ² in the second distance image becomes a target error of 1.5 cm or less at a predetermined degree of reliability (as will be described later, in this example, the degree of reliability is 68.3%). At this time, the average value Ave is 101.56 cm, and this value is the distance measurement value in the second distance image.

Furthermore, when determining the imaging number, though the imaging count determination unit 22 sequentially calculates the distribution of the distance measurement value σₙ² in units of corresponding pixels between the plurality of first distance images, when compositing only the image area of the target W having a surface of a certain height when viewed from the distance measurement sensor 10, the distribution σₙ² may be sequentially calculated in units of corresponding pixel regions (for example, 3×3 pixel regions) among the plurality of first distance images. By using the distance measurement values of more pixels in this way, the imaging number can be further reduced and wasted time can be reduced.

Further, when determining the imaging number, the target error σ_{TG} may be a predetermined fixed value, or may be a designated value designated by the user. For example, when the target error σ_{TG} is designated at 1 cm, since the right-hand side value αₙ²/1² of the determination formula 3 becomes the sequential distribution σₙ² itself, the graph of FIG. 4 also shows the time point B when the current imaging number n (solid line) exceeds the sequential distribution σₙ² (dashed line). Specifically, when the imaging number n of the first distance image represents a 92nd repetition, it is ultimately shown that the distance measurement error σₙ² in the second distance image becomes the target error 1 cm or less at a predetermined degree of reliability. At this time, the average value Ave is 100.61 cm, and this value is the distance measurement value of the second distance image.

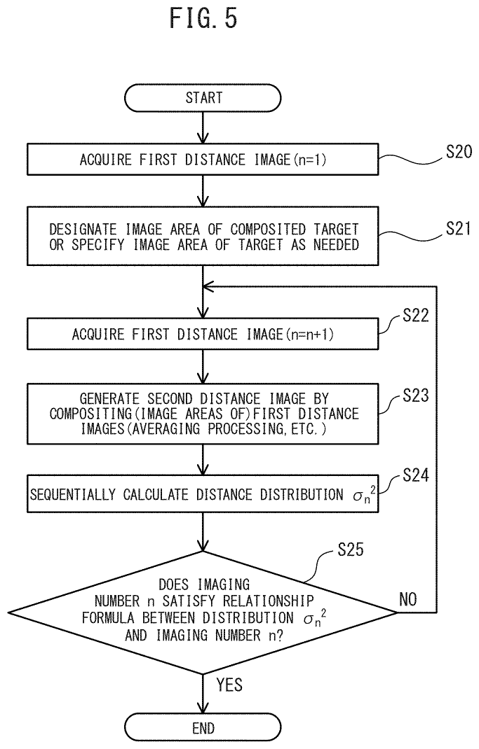

FIG. 5 shows the flow of an imaging number determination processing by a sequential method. First, in step S20, a first distance image is acquired in a first imaging (n=1). In step S21, the image area of the composited target is manually designated based on the acquired image or the image area in which at least a part of the target W is captured is automatically specified as needed.

In step S22, a further first distance image is acquired (n=n+1), and in step S23, (the image areas of) the plurality of first distance images are composited to generate a second distance image (by performing an averaging process or the like). When the compositing process of the first distance images in step S23 is not an averaging process for averaging the distance for each corresponding pixel, the compositing process may be performed after determining the imaging number n (i.e., after step S25).

In step S24, the distribution σₙ² of the distance required for estimation of the distance measurement error in the second distance image is sequentially calculated. At this time, the distribution σₙ² may be calculated in units of corresponding pixels of (the image areas of) the plurality of first distance images or in units of corresponding pixel regions in (the image areas of) the plurality of first distance images.

In step S25, it is determined whether the imaging number n satisfies the determination formula 4 representing the relationship between the sequentially calculated distribution σₙ² and the imaging number n. Specifically, by determining the end of acquisition of first distance images, the imaging number n of the first distance image is automatically determined.

When the imaging number n does not satisfy determination formula 4 in step S25 (NO in step S25), the process returns to step S22 and a further first distance image is acquired.

When the imaging number n satisfies the determination formula 4 in step S25 (YES in step S25), the acquisition of first distance images is ended, and the second distance image at this time becomes the final second distance image.

Contrary to the original distance measurement value variation, when the first few distance measurement values are accidentally similar values, there is a risk that the sequentially calculated distribution σₙ² becomes smaller and the determination formula 4 is satisfied even though the error of the second distance image is not less than the desired value. In order to eliminate this risk, a determination step of n K (where K is the minimum imaging number) may be provided before the determination in step S25.

The loop from step S22 to step S25 may be continued until the determination formula 4 is established for all pixels of the entire regions of the first distance images or the image area designated in step S21, or in consideration of pixel failure, the loop may be exited when the determination formula 4 is established with a predetermined ratio of pixels to the number of pixels in the image area, or alternatively, a maximum imaging number may be designated and the loop may be exited when the maximum imaging number is exceeded. Thus, the distance image capture system 1 may comprise a minimum imaging number designation unit, an establishment ratio designation unit for designating an establishment ratio of determination formula 4, and a maximum imaging number designate unit. For example, it is preferable that the user interface be provided with a numerical input field or the like for the user to designate these.

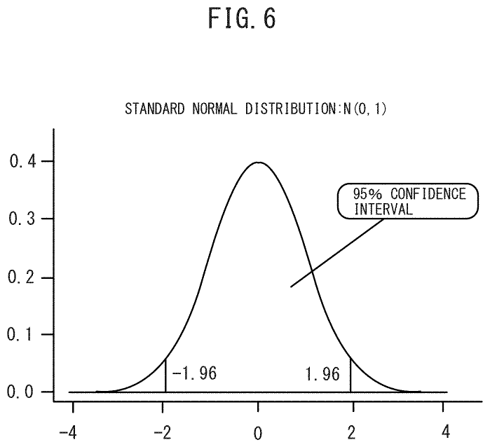

Next, a modified example of designating the degree of reliability of the distance measurement error in the second distance image will be described. Generally, when the variation of values is normally distributed, though the mean value can be estimated with high accuracy by increasing the number of samples, an error remains with respect to the true mean value. Thus, statistically, the relationship of the confidence interval with the margin of error E, the number of samples n, and the deviation a is defined. FIG. 6 is a graph showing the relationship of the 95% confidence interval in the standard normal distribution N(0, 1), and shows that 95% of the area (=probability) is distributed in the range of −1.966 to +1.966. Thus, when the deviation σ of the population is known and the confidence interval is 95%, the relationship of the following formula between the margin of error E and the number of samples n holds.

$$\begin{matrix}[ Math 8 ] & \\ ε = 1.96 \times \frac{σ}{\sqrt{n}} & 8\end{matrix}$$

Thus, in the case of the function method, the imaging number N for achieving the target error σ_{TG} with a degree of reliability of 95% can be obtained from the estimated distance measurement error σ₁ in the first distance image by the following formula.

$$\begin{matrix}[ Math 9 ] & \\ N = {( \frac{1.96}{{σ}_{TG}} )}^{2} \times {σ}_{1}^{2} & 9\end{matrix}$$

Similarly, in the sequential method, whether or not the imaging number n achieves the target error σ_{TG} with a degree of reliability of 95% can be determined by the following formula.

$$\begin{matrix}[ Math 10 ] & \\ n \geq {( \frac{1.96}{{σ}_{TG}} )}^{2} \times {σ}_{n}^{2} & 10\end{matrix}$$

Thus, in the case of a 95% confidence interval, the confidence coefficient is 1.96, in the case of a 90% confidence interval, the confidence coefficient becomes 1.65, and in the case of a 99% confidence interval, the confidence coefficient becomes 2.58. Further, when the confidence coefficient is 1, the confidence interval is 68.3%. Thus, the imaging number determined by the function method and sequential method described above is an imaging number in which the estimated distance measurement error is equal to or less than the target error σ_{TG} at a 68.3% of degree of reliability.

Designating with a degree of reliability added to the target error in this manner enables more intuitive designation with respect to tolerance, whereby a second distance image having a degree of reliability corresponding to the request of the user can be generated. Referring again to FIG. 1, the distance image capture system 1 may further comprise a reliability designation unit 26 for designating such a degree of reliability cd. The degree of reliability cd may be a confidence interval ci or a confidence coefficient cc. For example, it is preferable that the user interface be provided with a numerical input field or the like for the user to designate the degree of reliability cd.

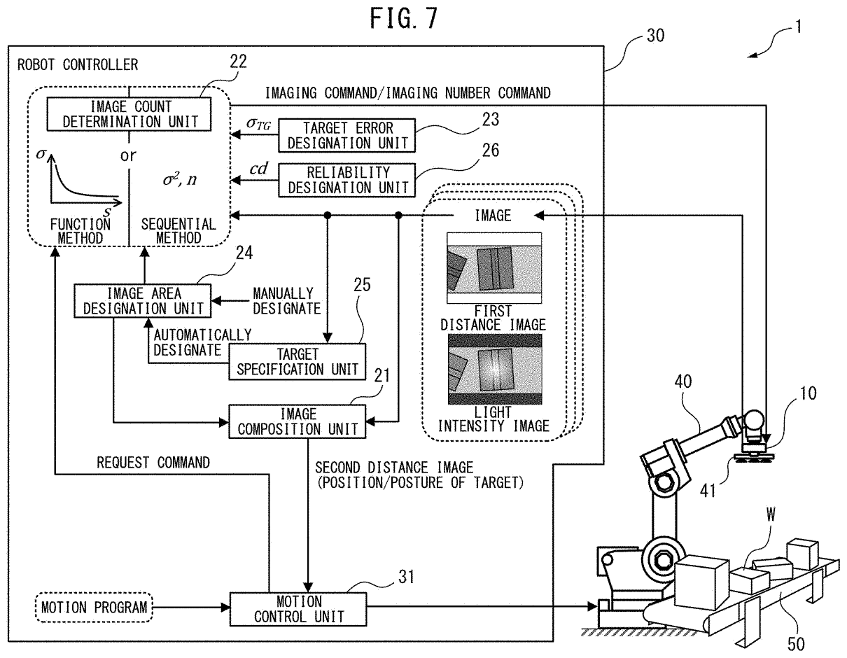

FIG. 7 shows a modified example of the configuration of the distance image capture system 1. Unlike the distance image capture system described above, the distance image capture system 1 does not comprise a host computing device 20. Specifically, all of the constituent elements implemented in the host computing device 20 are incorporated in the robot controller 30. In this case, the robot controller 30 issues an imaging command to the image acquisition unit 10. Such a stand-alone configuration is suitable for a robot system including one robot 40 and one robot controller 30. In addition, all of the features implemented in the host computing device 20 may be implemented as a part of the functions of the distance measurement sensor.

The programs executed by the processor described above and the programs for executing the flowcharts described above may be recorded and provided on a computer-readable non-transitory recording medium such as a CD-ROM, or may be distributed and provided wired or wirelessly from a server device on a WAN (wide area network) or LAN (local area network).

According to the embodiment described above, since the imaging number is automatically adjusted, there can be provided an image compositing technology which achieves stable distance measurement accuracy and a reduction of wasted time, even if the target W changes.

Though various embodiments have been described herein, it should be noted that the invention is not limited to the embodiments described above and can be modified within the scope described in the claims.

### REFERENCE SIGNS LIST

1 distance image capture system
10 image acquisition unit (distance measurement sensor)
20 host computing device
21 image composition unit
22 image count determination unit
23 target error designation unit
24 image area designation unit
25 target specification unit
26 reliability designation unit
30 robot controller
31 motion control unit
40 robot
41 tool
50 conveyance device
W target

1. A distance image capture system, comprising an image acquisition unit which acquires a plurality of first distance images by imaging a target multiple times from the same imaging position and the same imaging posture with respect to the target, and an image composition unit which generates a second distance image by compositing the plurality of first distance images, the system comprising:
an image count determination unit which estimates a distance measurement error in the second distance image and determines an imaging number of the first distance images so that the estimated distance measurement error becomes equal to or less than a predetermined target error.

2. The distance image capture system according to claim 1, wherein the image acquisition unit further has a function for acquiring a light intensity image by imaging the target from the same imaging position and the same imaging posture, and the image count determination unit determines the imaging number of the first distance images based on the light intensity image.

3. The distance image capture system according to claim 2, wherein the image count determination unit estimates the distance measurement error from the light intensity image based on a relationship between light intensity and distance measurement variation.

4. The distance image capture system according to claim 3, wherein the image count determination unit estimates the distance measurement error in units of pixels in the light intensity image or in units of pixel regions in the light intensity image.

5. The distance image capture system according to claim 1, wherein the image count determination unit sequentially calculates a distribution of distance each time a first distance image is captured and determines an end of acquisition of the first distance images based on a relationship between the distribution and the imaging number.

6. The distance image capture system according to claim 5, wherein the image count determination unit sequentially calculates the distribution in units of corresponding pixels between the plurality of first distance images or in units of corresponding pixel regions between the plurality of first distance images.

7. The distance image capture system according to claim 1, further comprising an image area designation unit which designates an image area of a composited target, wherein the image count determination unit estimates the distance measurement error in the image area designated by the image area designation unit.

8. The distance image capture system according to claim 7, further comprising a target specification unit which specifies an image area in which at least a part of the target is captured, wherein the image area designation unit designates the image area specified by the target specification unit as an image area of the composited target.

9. The distance image capture system according to claim 1, further comprising a reliability designation unit which designates a degree of reliability of the distance measurement error in the second distance image.

10. The distance image capture system according to claim 1, wherein the image acquisition unit is installed in a robot tip part or fixed point.

11. The distance image capture system according to claim 1, wherein the image acquisition unit is a TOF sensor.

12. The distance image capture system according to claim 1, further comprising a robot, a robot controller which controls the robot, and a host computing device which comprises the image composition unit and the image count determination unit, wherein the robot controller issues a request command for the second distance image to the host computing device.

13. The distance image capture system according to claim 1, further comprising a robot and a robot controller which controls the robot, wherein the image composition unit and the image count determination unit are incorporated in the robot controller.

14. The distance image capture system according to claim 12, wherein the robot controller corrects motion of the robot based on the second distance image.
